(19) United States
(12) Patent Application Publication
(10) Pub. No.: US 2022/0374655 A1
(43) Pub. Date: Nov. 24, 2022

(54) DATA SUMMARIZATION FOR TRAINING MACHINE LEARNING MODELS

(71) Applicant: FUJITSU LIMITED, Kawasaki-shi (JP)

(72) Inventors: Angus LOWE, Sunnyvale, CA (US); Sarvagya UPADHYAY, San Jose, CA (US)

(73) Assignee: FUJITSU LIMITED, Kawasaki-shi (JP)

(21) Appl. No.: 17/322,467

(22) Filed: May 17, 2021

(51) Int. Cl. G06K 9/62; G06N 20/10; G06N 10/00

(52) U.S. Cl. CPC G06K 9/6257; G06K 9/6231; G06K 9/6272; G06N 20/10; G06K 9/622; G06N 10/00

(57) ABSTRACT

A method may include obtaining a dataset including one or more data points. The method may include separating the dataset into one or more partitions based on a target number of subjects and a dimensionality of the data points included in the dataset. The method may include obtaining one or more weight vectors, each respective weight vector corresponding to a respective subject. The method may include selecting a first partition of the plurality of partitions to remove from the dataset based on respective relationships between a first weighted centroid of the dataset and first partition weights corresponding to each of the partitions. The method may include obtaining a first subset of the dataset by removing the data points associated with the selected first partition from the dataset. The method may include training a machine learning model based on the first subset of the dataset.

The present disclosure generally relates to data summarization for training machine learning models.

### BACKGROUND

A machine learning model may be trained to analyze and/or perform a variety of tasks. The machine learning model may be trained using a training dataset including a number of data points related to the task to be performed by the machine learning model.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

One or more embodiments of the present disclosure may include a method that includes obtaining a dataset including one or more data points. The method may include separating the dataset into one or more partitions based on a target number of subjects and a dimensionality of the data points included in the dataset. The method may include obtaining one or more weight vectors, each respective weight vector corresponding to a respective subject. The method may include selecting a first partition of the plurality of partitions to remove from the dataset based on respective relationships between a first weighted centroid of the dataset and first partition weights corresponding to each of the partitions. The method may include obtaining a first subset of the dataset by removing the data points associated with the selected first partition from the dataset. The method may include training a machine learning model based on the first subset of the dataset.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1A is a diagram representing an example system for training a machine learning model based on data points included in a core dataset according to the present disclosure;

FIG. 1B illustrates determining a core dataset based on one or more of data points;

FIG. 2 is a flowchart of an example method of training a machine learning model based on data points included in a core dataset according to the present disclosure;

FIG. 3 is a flowchart of an example method of training a quantum machine learning model based on data points included in a core dataset according to the present disclosure; and

FIG. 4 is an example computing system.

### DETAILED DESCRIPTION

Training a machine learning model may depend on the number of data points included in the dataset used to train the machine learning model. While training a machine learning model based on a training dataset including a large number of data points may present various advantages, the training dataset including the large number of data points may include redundant data. Introducing redundant data to the machine learning model may increase the time needed to train the machine learning model without improving the accuracy of the machine learning model. Further, in some instances, the amount of data of some datasets may make some techniques or systems that are used to train machine learning models (e.g., noisy intermediate-scale quantum (NISQ) devices) difficult, impractical, or impossible due to the large datasets potentially using more resources than may be available.

Carathéodory's theorem in convex geometry states that every point in a convex hull having a dimensionality of R^{d} can be represented as a convex combination of at most d+1 points in the convex hull. Carathéodory's theorem may be represented by the following mathematical expression:

$$μ = {\sum }_{i ∈ S} w ( i ) {v}_{i} \qquad ( 1 )$$

in which a point μ is represented by the summation of points included in a subset S of the convex hull having a size less than or equal to d+1. The subset S may be represented as {v₁, v₂, . . . , v_{d+1}}, and each point included in the subset S may be modified by a weight w(i) in which the weights w(i) are non-negative and sum up to one.

The present disclosure may, among other things, facilitate training a machine learning model based on a subset of data points derived from a dataset including a number of data points. In some embodiments, construction of the subset may be facilitated by principles of Carathéodory's theorem such that the data points included in the subset are representative of the dataset from which the subset is constructed. These and other embodiments of the present disclosure may provide improvements over previous iterations of machine learning models and machine-learning training processes. As such, the functionality of a computing system implementing embodiments of the present disclosure may be improved by increasing the training speed of machine learning models implemented on the computing system while maintaining a target level of accuracy of the trained models. Additionally or alternatively, the amount of processing resources that may be used to train the models may be reduced.

Additionally or alternatively, embodiments of the present disclosure may facilitate implementation of quantum machine learning on noisy intermediate-scale quantum (NISQ) devices. NISQ devices include computing systems configured to perform quantum computing operations that are otherwise infeasible and/or impossible for classical computing systems to perform. Existing quantum computing devices obtain and process information using quantum bits (qubits), which represent the basic unit of quantum information regarding the state of a quantum system. NISQ devices may include fewer numbers of quantum bits (qubits) relative to the number of bits included in classical computing devices, and a large number of qubits may be required for quantum computing systems to perform operations that are infeasible for classical computing systems. Performing computations for training a quantum machine learning model using a NISQ device may be impractical because NISQ devices may not include sufficient qubits for performing the operations necessary to train the quantum machine learning model. As such, training of a quantum machine learning model implemented on one or more NISQ devices may be facilitated and/or improved by representing a large dataset using a subset of data points representative of the larger dataset according to the present disclosure. Further, the ability to use a subset of data points may allow for using NISQ devices to train quantum machine learning models based on datasets that may otherwise be too large.

Embodiments of the present disclosure are explained with reference to the accompanying figures.

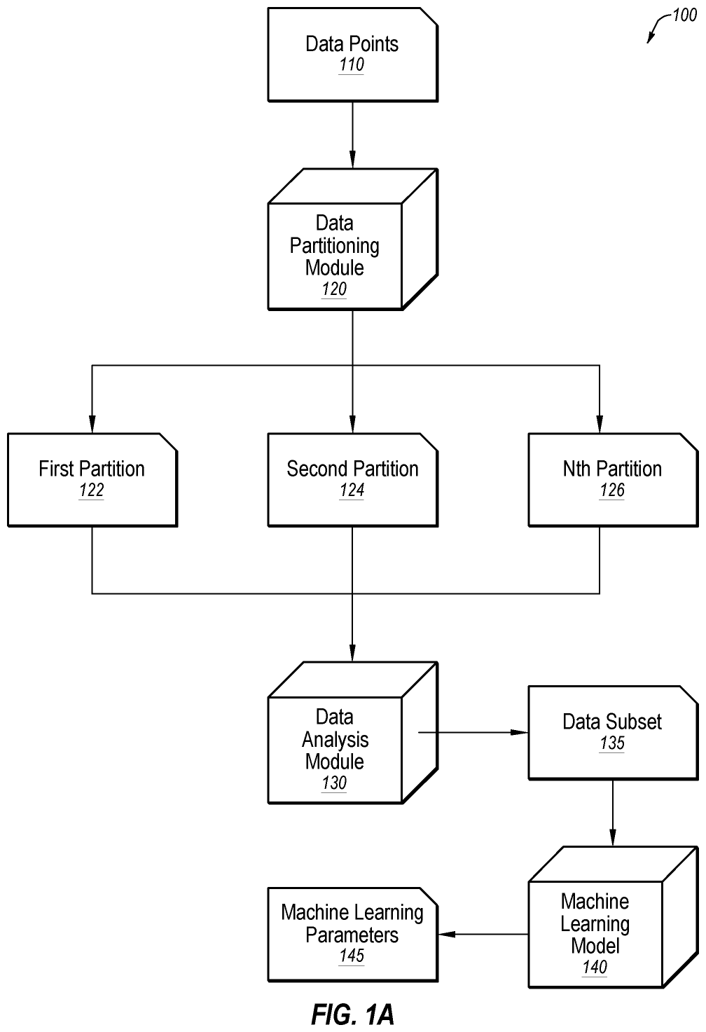

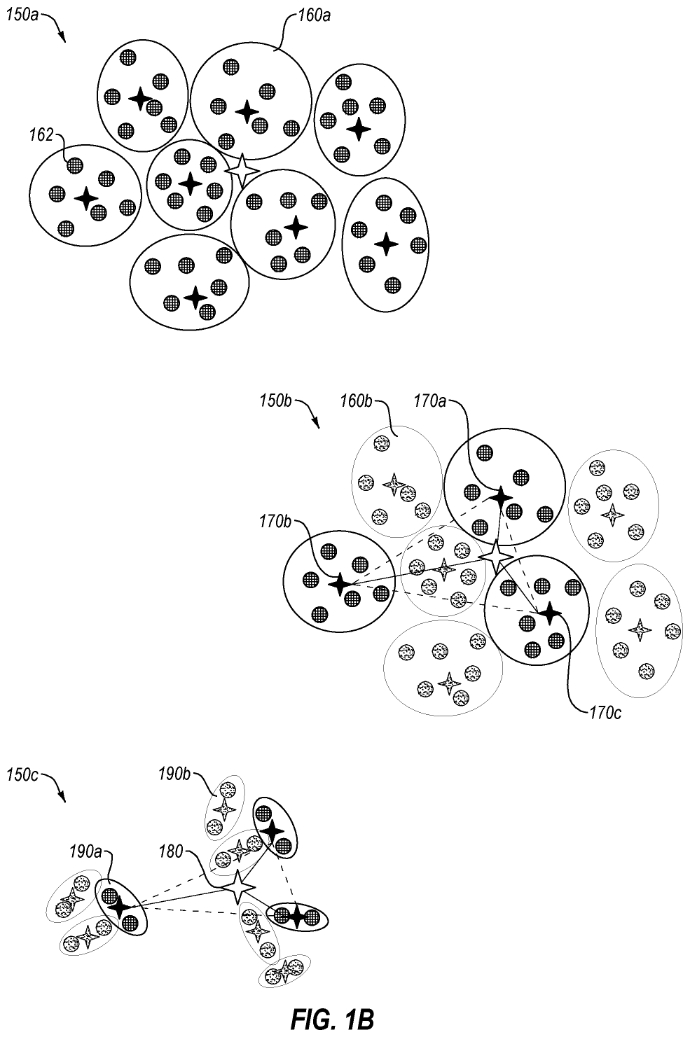

FIG. 1A is a diagram representing an example system 100 for training a machine learning model 140 based on data points included in a core dataset according to the present disclosure. The system 100 may include a data partitioning module 120, a data analysis module 130, and/or the machine learning model 140.

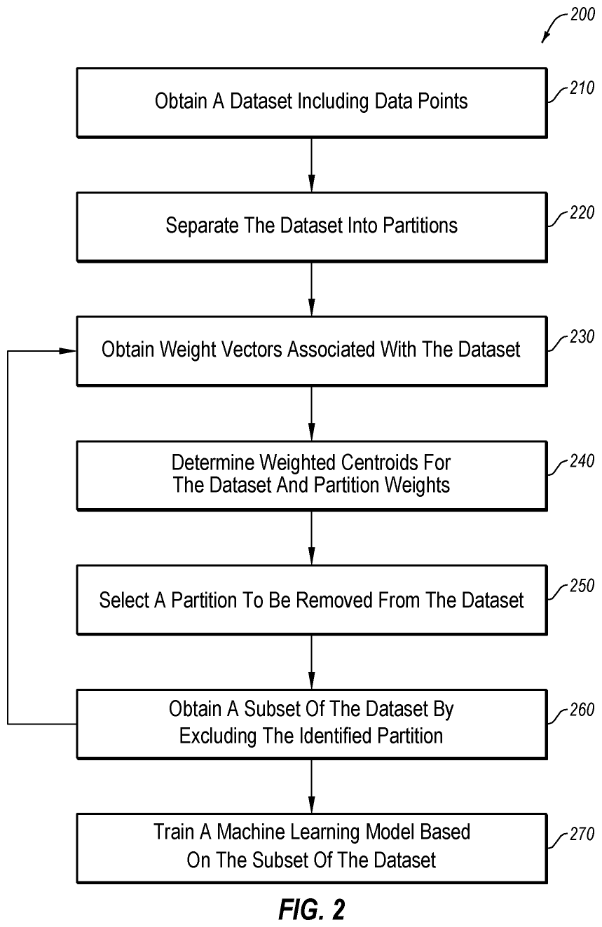

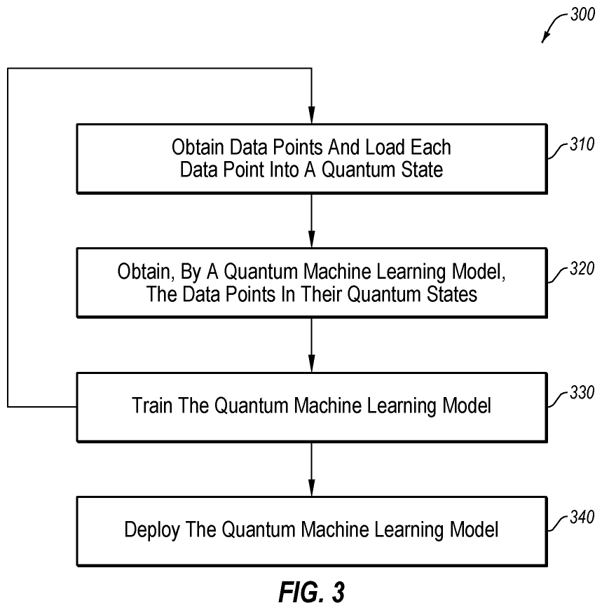

The data partitioning module 120, the data analysis module 130, and/or the machine learning model 140 may each include code and routines configured to enable a computing system to perform one or more operations. Additionally or alternatively, one or more of the respective modules may be implemented using hardware including a processor, a microprocessor (e.g., to perform or control performance of one or more operations), a field-programmable gate array (FPGA), or an application-specific integrated circuit (ASIC). In some other instances, one or more of the respective modules may be implemented using a combination of hardware and software. In the present disclosure, operations described as being performed by the data partitioning module 120, the data analysis module 130, and/or the machine learning model 140 may include operations that the data partitioning module 120, the data analysis module 130, and/or the machine learning model 140 may respectively direct a corresponding system to perform. The data partitioning module 120, the data analysis module 130, and/or the machine learning model 140 may be configured to perform a series of operations with respect to one or more data points 110, partitions 122-126, and/or a data subset 135 as described in further detail below in relation to at least methods 200 and/or 300 of FIGS. 2 and 3, respectively.

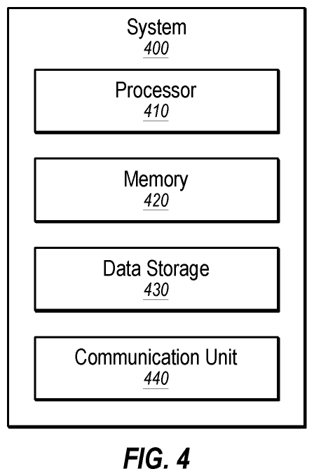

In some embodiments, the data partitioning module 120, the data analysis module 130, and/or the machine learning model 140 may each be included in a same computing system, such as example computing system 400 as described in relation to FIG. 4. Additionally or alternatively, the data analysis module 130 and/or the machine learning model 140 may be included in a first computing system, and the data partitioning module 120 may be included in a second computing system that is configured to interface with the first computing system. Further, the data partitioning module 120, the data analysis module 130, and the machine learning model 140 are illustrated and described as separate elements to facilitate explanation of the present disclosure. As such, any suitable hardware and/or software arrangement configured to perform the operations described as being performed by the data partitioning module 120, the data analysis module 130, and/or the machine learning model 140 is within the scope of the present disclosure.

A dataset including the one or more data points 110 may be obtained by the data partitioning module 120. The dataset may include any number of d-dimensional data points 110. For instance, in mathematical terms, a given dataset “V” may be expressed as:

V={v₁,v₂, . . . ,vₙ}⊆ [symbol] ^{d} (2)

in which the given dataset “V” includes “n” data points “v”, each of the data points including a dimensionality of “d”.

In some embodiments, each of the data points 110 obtained by the data partitioning module 120 may include a vector having a dimensionality of “d”. The dimensionality of the data points 110 describes a number of coordinates used to represent locations of each of the data points 110 in a vector space. For example, a particular data point located within a cubic space may be represented by a set of three coordinates (e.g., “<x, y, z>” in a Cartesian coordinate system) such that the particular data point includes a dimensionality of 3. As another example, a particular higher-dimensional data point may be represented by a set of six coordinates (e.g. “<x, y, z, α, β, γ>”) such that the particular higher-dimensional data point includes a dimensionality of 6.

The data partitioning module 120 may separate the data points 110 included in the dataset into a number of disjoint partitions, such as a first partition 122, a second partition 124, and/or an Nth partition 126, in which each data point 110 of the dataset is included in only one partition. In these and other embodiments, each of the partitions 122-126 may include approximately the same number of data points or the same number of data points 110. For example, a particular dataset may include twelve thousand data points, and the data partitioning module 120 may determine that the particular dataset may be separated into twelve partitions. The data points associated with the particular dataset may be divided between the twelve partitions such that approximately one thousand data points are included in each partition. In mathematical terms, a set of “r” partitions “P” may be expressed as “{P₁, P₂, . . . Pᵣ}.”

The data partitioning module 120 may determine a number of partitions (e.g., a number of partitions corresponding to the Nth partition 126) into which the data points 110 may be divided based on the dimensionality of the data points 110 and a target number of represented subjects. For example, in some embodiments, the number of partitions may be expressed as:

r=2k(d+1) (3)

in which “r” represents the number of partitions, “k” represents the target number of represented subjects, and “d” represents the dimensionality of the data points 110 included in each of the partitions 122-126.

In some embodiments the target number of represented subjects may indicate a number of parameters associated with a topic related to the machine learning model. The target number of represented subjects may be an inherent aspect of the topic and/or task related to the machine learning model. In some embodiments, the partitioning module 120 may obtain the represented subjects from a user input that includes information about a machine learning task. In these or other embodiments, the user input may specifically indicate the subjects. Additionally or alternatively, the subjects may be implicitly included in the user input based on the information about the machine learning task and the data partitioning module 120 may be configured to extract the subjects based on the information about the machine learning task. For example, the information about the machine learning task may relate to training a machine learning model to predict trends in a financial and/or economic dataset, which may include analysis of a weighted average, a simple moving average, and an exponential moving average of the financial and/or economic dataset. In such an example, the data partitioning module 120 may be configured to determine that target number of represented subjects is three based on the three topics of the financial and/or economic dataset to be analyzed (the weighted average, the simple moving average, and the exponential moving average).

One or more non-negative weight vectors associated with the dataset may be identified based on the target number of represented subjects. In some embodiments, the data partitioning module 120 may obtain the weight vectors from a user input that includes information about the data points 110 and/or the machine learning task. In these and other embodiments, the user input may specifically indicate the weights corresponding to each data point. Additionally or alternatively, the weights may be implicitly included in the user input based on the information about the machine learning task and the data partitioning module 120 may be configured to extract the weights based on the information about the machine learning task and/or the data points 110. Each element included in a given weight vector may represent the importance of a data point corresponding to the respective element relative to a represented subject. As such, each of the weight vectors may include a number of weight elements corresponding to the number of data points included in the dataset, and the number of weight vectors may correspond to the target number of represented subjects. In some embodiments, the values of each element included in a particular weight vector may sum to one. For example in mathematical terms, a particular weight vector “a” including four weights (corresponding to a particular dataset including four data points) may be represented as:

$$a = < {a}_{1} , {a}_{2} , {a}_{3} , {a}_{4} > and {\sum }_{i = 1} {a}_{i} = 1 \qquad ( 4 )$$

In this example, the first weight “a₁” may describe the relative importance of a first data point included in the particular dataset. The second weight “a₂” may describe the relative importance of a second data point included in the particular dataset. The third weight “a₃” may describe the relative importance of a third data point included in the particular dataset, and the fourth weight “a₄” may describe the relative importance of a fourth data point included in the particular dataset. The weight vectors may indicate the relative importance of particular data points included in the dataset to a weighted centroid of the dataset as described in further detail below.

In some embodiments, the number of partitions may be determined according to expression (3) to ensure that the null space of a matrix “M” is large enough to include a number of vectors that satisfy the conditions as described in further detail below in relation to the data analysis module 130. As such, the coefficient associated with the target number of represented subjects in expression (3) typically may be greater than one (e.g., two as shown in expression (3)).

The data analysis module 130 may obtain one or more of the partitions 122-126 and perform one or more data analysis operations on the partitions 122-126 and/or the data points associated with the partitions 122-126 to determine the data subset 135. In some embodiments, the data analysis module 130 may determine a partition weight corresponding to each of the partitions 122-126 and calculate a weighted centroid representative of the dataset based on the determined partition weights. Additionally or alternatively, the data analysis module 130 may identify one or more partitions as having the least influence on the weighted centroid of the dataset and determine a subset of the dataset (e.g., the data subset 135) based on excluding the one or more partitions identified as having the least influence.

To facilitate removal of the one or more partitions, the data analysis module 130 may first determine a weighted centroid of the dataset corresponding to each respective weight vector. The weighted centroid of the dataset may describe a location in a vector space of the dataset identified as being representative of the data points included in the dataset factoring in the weight (e.g., significance) of each data point. As such, a number of weighted centroids determined by the data analysis module 130 may correspond to the number of weight vectors, and by extension, the target number of represented subjects. In other words, a weighted centroid may be determined for each represented subject included in a particular dataset because each data point 110 included in the particular dataset may include different weights in relation to each represented subject.

For example, a particular dataset including two represented subjects may include two weight vectors. A weighted centroid of the particular dataset may be calculated based on each of the two weight vectors and the data points included in the particular dataset such that two weighted centroids are determined for the particular dataset. In mathematical terms, the two weight vectors associated with the particular dataset may be represented as a first weight vector a and a second weight vector “b.” Each of the weight vectors may include a first term “a₁” or “b₁,” a second term “a₂” or “b₂,” and up to a Nth term “aₙ” or “bₙ” as described above in relation to expression (4). The weighted centroid “xₐ” of the particular dataset including data points 110 as described above in relation to expression (2) associated with the first weight vector may be calculated as the summation of the product of each data point 110 and a respective weight corresponding to each respective data point 110. The weighted centroid of the particular data set may be expressed as:

$${x}_{a} = {\sum }_{i = 1}^{n} {a}_{i} {v}_{i} \qquad ( 5 )$$

The data analysis module 130 may determine a weighted centroid corresponding to each partition for each respective represented subject. The weighted centroid corresponding to a particular partition may indicate a location in the vector space of the particular partition identified as being representative of the data points included in the particular partition factoring in the weight (e.g., significance) of each data point. In some embodiments, a number of weighted centroids determined for a particular partition may correspond to the target number of represented subjects. For example, a particular dataset including two represented subjects may include two weight vectors “a” and “b,” and each partition including data points from the particular dataset may include two weighted centroids “μⱼ” and “λⱼ.” The weighted centroids of a particular partition may be calculated as the summation of the product of each data point 110 included in the particular partition and a respective weight corresponding to each respective data point 110. The weighted centroids corresponding to each partition may be expressed as:

μⱼ=Σ_{i∈P}_{ⱼ}aᵢvᵢ and λⱼ=Σ_{i∈P}_{ⱼ}bᵢvᵢ (6)

In these and other embodiments, the data analysis module 130 may construct the matrix “M” to facilitate identification and selection of the first partition for removal from the dataset. The dimensions of the matrix “M” may correspond to the dimensionality “d” of the data points 110 included in the dataset and the number of partitions “r” such that the matrix is a d×r matrix (e.g., the matrix includes “d” rows and “r” columns). Each column of the matrix “M” may include elements based on the weighted centroids associated with each of the partitions (e.g., “μⱼ” and “λⱼ” as described above in relation to expression (6)) determined by the following mathematical expression:

μᵢ−μ₁ (7)

The data analysis module 130 may compute a null space of the matrix “M” including a set of vectors “xᵢ” such that at least one of the vectors included in the set satisfies the following conditions:

$$M {x}_{i} = 0 \qquad ( 8 )$$

$${x}_{i} ( 1 ) = - {\sum }_{j = 2}^{r} {x}_{i} ( j ) \qquad ( 9 )$$

The set of vectors may be determined by factoring the matrix “M” (e.g., via singular value decomposition) to determine the set of vectors such that the number of vectors included in the set of vectors is at least equal to twice the number of partitions. In other words, the set of vectors may include vectors “{x₁, x₂, . . . , xₖᵣ}.”

The above operations described in relation to expressions (7)-(9) may facilitate identification of one or more non-zero indices based on the set of vectors “{x₁, x₂, . . . , xₖᵣ}.” Each element included in the non-zero indices may represent a respective partition of the dataset to facilitate removal of one or more partitions from the dataset and/or re-weighing the remaining partitions after the removal.

The data analysis module 130 may determine a partition weight corresponding to each partition for each respective represented subject. The partition weights may indicate the importance of the partitions associated with each respective partition weight in relation to a respective represented subject. In some embodiments, the partition weight may be determined to be a total importance of the weights corresponding to the data points included in a particular partition. For example, a particular dataset including two represented subjects may include two weight vectors “a” and “b,” and each partition including data points from the particular dataset may include two partition weight vectors “cⱼ” and “dⱼ” expressed as:

cⱼ=Σ_{i∈P}_{ⱼ}aᵢ and dⱼ=Σ_{i∈P}_{ⱼ}bᵢ (10)

The data analysis module 130 may determine a first data subset 135 of the dataset. In some embodiments, the data analysis module 130 may select a first partition of the partitions 122-126 to remove from the dataset based on respective relationships between the weighted centroid of the dataset and each of the partition weights. In these and other embodiments, the first data subset 135 may include the data points included in the partitions 122-126 minus the data points included in the selected first partition.

In some embodiments, selection of the first partition for removal from the dataset may include identifying a partition as having a least influence on determining the weighted centroid of the dataset by comparing the respective partition weights of each partition to the weighted centroid to determine which partitions corresponding to the partition weights contributes the least to the representation of the weighted centroid.

For each of the vectors that satisfies the conditions expressed in expressions (8) and (9), one or more centroid-reduction coefficients may be calculated corresponding to the target number of represented subjects. For example, a first centroid-reduction coefficient “a” may be calculated based on the partition weights of each partition corresponding to a first represented subject. The first centroid-reduction coefficient “a” may indicate how to readjust the weight vector corresponding to the first represented subject (e.g., weight vector “a” as described above) in response to removal of the first partition. As such, the first centroid-reduction coefficient “a” may be described according to the following expression:

$$α = min \{ \frac{{c}_{j} ( i )}{{x}_{1} ( i )} : {x}_{1} ( i ) > 0 \} \qquad ( 11 )$$

in which each partition weight “cⱼ(i)” associated with a first represented subject is compared to each positive index “x₁(j)” and a minimum value of all the comparisons is identified.

In some embodiments in which the target number of represented subjects is two or greater, a relational term “l*” may be determined to establish a relationship between the index at which the first centroid-reduction coefficient is determined and an index at which a second centroid-reduction coefficient may be calculated. The relational term “l*” may indicate which partition may be selected for removal from the dataset and includes the index at which the first centroid-reduction coefficient is determined. The relational term “l*” may expressed as:

$${l}^{*} = arg min \{ \frac{{c}_{j} ( i )}{{x}_{1} ( i )} : {x}_{1} ( i ) > 0 \} \qquad ( 12 )$$

In these and other embodiments, the second centroid-reduction coefficient “β” may indicate how to readjust the weight vector corresponding to the second represented subject (e.g., weight vector “b” as described above) in response to removal of the first partition. The index at which the second centroid-reduction coefficient may be calculated based on the relational term “l*” according to the following expression:

$${l}^{*} = arg min \{ \frac{{d}_{j} ( i )}{{x}_{h} ( i )} : {x}_{h} ( i ) > 0 \} \qquad ( 13 )$$

The partition weight “dⱼ(i)” corresponding to the second represented subject may be identified based on the index described by the relational term “l*” according to the following expression:

$$β = min \{ \frac{{d}_{j} ( i )}{{x}_{h} ( i )} : {x}_{h} ( i ) > 0 \} \qquad ( 14 )$$

The index corresponding to the first partition selected for removal may be set to zero based on the one or more centroid-reduction coefficients (e.g., “α” in relation to a first represented subject and/or “β” in relation to a second represented subject) and updated partition weight vectors (e.g., “cⱼ” corresponding to a first represented subject and/or “dⱼ′” corresponding to a second represented subject) may be determined. The updated partition weight vectors may be calculated based on the following expressions:

cⱼ′=cⱼ−αx₁ (15)

dⱼ′=dⱼ−βxₕ (16)

Because the centroid-reduction coefficients are calculated according to expressions (11) and (14), the index included in the updated partition weight vectors associated with the first partition selected for removal is set to zero according to expressions (15) and (16).

An updated set of partitions “S” may be constructed based on the updated partition weight vectors by removing the index of the removed first partition from the updated partition weight vectors. A subset of the dataset “S” may be identified by removing a partition corresponding to the jth term of the updated partition weight vectors. In some embodiments, construction of the updated set of partitions may be expressed as:

S={j: either cⱼ′>0 or dⱼ′>0 or both} (17)

Additionally or alternatively, the weight vectors (e.g. “a” and “b”) may be updated based on the updated partition weight vectors according to the following expressions:

$$V ← {⋃}_{j ∈ S} {P}_{j} \qquad ( 18 )$$

$${a}_{i} ← \frac{{c}_{j}^{′} {a}_{i}}{{c}_{j}} and {b}_{i} ← \frac{{d}_{j}^{′} {b}_{i}}{{d}_{j}} for all i ∈ {P}_{j} \qquad ( 19 )$$

In some embodiments, one or more iteration conditions may be determined, and the operations of the data analysis module 130 may be performed iteratively until the iteration conditions are satisfied. In some embodiments, the iteration conditions may include specifying a number and/or percentage of partitions to be removed from the dataset, specifying a number and/or percentage of data points to be removed from the data points 110, satisfying one or more data analysis metrics, achieving a threshold accuracy for performance of the machine learning model, etc.

Iterative operation of the data analysis module 130 may facilitate removal of data points from the data subset 135 such that the training dataset provided to the machine learning model 140 includes fewer data points while maintaining a target level of accuracy of the machine-learning training. In these and other embodiments, the data analysis module 130 may update the weighted centroid of the dataset based on the data points 110 included in the data subset 135 according to expression (5). Additionally or alternatively, the data analysis module 130 may iteratively update the partition weights associated with the partitions 122-126 included in the data subset 135. Additionally or alternatively, the data analysis module 130 may iteratively select a second partition, a third partition, etc. for removal from the data subset 135 to determine a second data subset, a third data subset, etc.

The machine learning model 140 may be trained to perform one or more tasks based on the data subset 135. In some embodiments, training the machine learning model 140 based on the data subset 135 may facilitate categorization of data points, presentation of user recommendations, analysis of trends between data points, performance of one or more tasks, etc. based on a new dataset. Additionally or alternatively, construction of the data subset 135 may facilitate training a quantum machine learning model as described in further detail below in relation to FIG. 3.

Modifications, additions, or omissions may be made to FIG. 1A without departing from the scope of the present disclosure. For example, the system 100 may include more or fewer elements than those illustrated and described in the present disclosure.

FIG. 1B illustrates determining a core dataset of a dataset 150a according to the present disclosure. The dataset 150a may include one or more two-dimensional data points 162, which may be representative of the data points 110 described in relation to FIG. 1A. The data points 162 may be clustered into one or more disjoint partitions, such as partition 160a and/or partition 160b. Each of the partitions may include the same number of data points 162 or approximately the same number of data points 162 and a weighted centroid 170 illustrated as a red, cross-shaped star. Additionally or alternatively, the dataset 150a may include a weighted centroid 180 illustrated as a green, cross-shaped star.

One or more of the partitions may be identified as having the least influence on the weighted centroid 180, such as described above. As illustrated in dataset 150b, five partitions including the partition 160b are identified as having the least influence on the weighted centroid 180. In some embodiments, each of the five partitions may be identified iteratively, such as described above with respect to FIG. 1A.

Consequently, the remaining three partitions may be characterized as having the most influence on the weighted centroid 180. The three partitions identified as having the most influence on the weighted centroid 180 including the partition 160a may be categorized as a subset of the dataset 150a, which may be representative of the data subset 135 described in relation to FIG. 1A, and the five partitions identified as having the least influence on the weighted centroid 180 may be excluded from the subset of the dataset 150a.

The subset 150c of the dataset may be further partitioned (e.g., into partitions 190a and 190b). In some circumstances, updated weighted centroids of the partitions may be determined while the weighted centroid 180 of the dataset remains unchanged. Additional partitions, such as the partition 190b, may be identified as having the least influence on the weighted centroid 180 and removed from the subset 150d. As such the subset 150d may include one or more partitions such as the partition 190a.

FIG. 2 is a flowchart of an example method 200 of training a machine learning model based on data points included in a core dataset according to the present disclosure. The method 200 may be performed by any suitable system, apparatus, or device. For example, the data partitioning module 120, the data analysis module 130, and/or the machine learning model 140 may perform one or more of the operations associated with the method 200. Although illustrated with discrete blocks, the steps and operations associated with one or more of the blocks of the method 200 may be divided into additional blocks, combined into fewer blocks, or eliminated, depending on the particular implementation.

The method 200 may begin at block 210, where a dataset is obtained. The dataset may include one or more data points, such as the data points 110 described above in relation to FIG. 1A. In some embodiments, the dataset may be a training dataset for a machine learning model. The data points included in the dataset may relate to a question of a user and/or a task a user wants to perform with which the machine learning model may assist after being trained. For example, the data points may include financial data such as a price of an asset at a particular point in time. A machine learning model may be trained to determine financial data analytics metrics, predict future performance, etc. of the asset and/or related assets based on the financial data.

At block 220, the dataset may be separated into one or more partitions. Separation of the dataset into the one or more partitions may be achieved as described above in relation to FIG. 1A.

At block 230, weight vectors associated with the dataset may be obtained. As described in relation to FIG. 1A, the number of weight vectors associated with a particular dataset may depend on the target number of represented subjects corresponding to the particular dataset. In some embodiments, the represented subjects and/or the weight vectors may be intrinsic properties of a particular dataset based on the question a machine learning model is configured to answer and/or a task the machine learning model is configured to perform. As such, the represented subjects and/or the weight vectors corresponding to a particular dataset may include user input provided to a particular computing system configured to train a machine learning model according to the present disclosure. Additionally, or alternatively, the represented subjects and/or the weight vectors corresponding to the particular dataset may be identified by the particular computing system based on previous datasets similar to the particular dataset.

At block 240, one or more weighted centroids of the dataset and one or more partition weights may be determined. Determination of the weighted centroids of the dataset and the partition weights may depend on the target number of represented subjects and the weight vectors associated with the dataset as described above in relation to FIG. 1A.

At block 250, a partition may be selected to be removed from the dataset. In some embodiments, selection of the partition to be removed from the dataset may be based on the respective relationships between the weighted centroid of the dataset and each of the partition weights. In these and other embodiments, the partition selected to be removed from the dataset may include a partition identified as having the least influence on the dataset. Selection of the partition may be achieved as described above in relation to FIG. 1A.

At block 260, a subset of the dataset may be obtained by excluding the data points included in the partition identified at block 250 from the dataset. In some embodiments, the weight vectors and/or the partition weights may be reevaluated based on the data points included in the subset as described above in relation to FIG. 1A. In other words, the method 200 may return to obtaining the weight vectors at block 230, and blocks 230-260 of the method 200 may be performed iteratively as described above in relation to FIG. 1A.

At block 270, a machine learning model may be trained based on the subset of the dataset. In some embodiments, the machine learning model may include a quantum machine learning model, and the data points included in the subset of the dataset may be loaded into qubits to facilitate training the quantum machine learning model as described below in relation to FIG. 3.

Modifications, additions, or omissions may be made to the method 200 without departing from the scope of the disclosure. For example, the designations of different elements in the manner described is meant to help explain concepts described herein and is not limiting. Further, the method 200 may include any number of other elements or may be implemented within other systems or contexts than those described.

FIG. 3 is a flowchart of an example method 300 of training a quantum machine learning model based on data points included in a core dataset according to the present disclosure. The method 300 may be performed by any suitable system, apparatus, or device. For example, the data partitioning module 120, the data analysis module 130, and/or the machine learning model 140 may perform one or more of the operations associated with the method 300. Although illustrated with discrete blocks, the steps and operations associated with one or more of the blocks of the method 300 may be divided into additional blocks, combined into fewer blocks, or eliminated, depending on the particular implementation.

The method may begin at block 310, where one or more data points are obtained, and each data point is loaded into a quantum state. In some embodiments, the obtained data points may include the data points 110 included in the data subset 135 as described above in relation to FIG. 1A. The data points may include data represented in a classical state, and loading the data points into a quantum state may include converting the classical bits representing the data points into a corresponding number of qubits.

At block 320, the qubits representing the data points may be obtained by a quantum machine learning model. In some embodiments, the quantum data points may be obtained by one or more NISQ devices on which the quantum machine learning model is implemented. At block 330, the quantum machine learning model may be trained based on the obtained quantum data points. In some embodiments, training the quantum machine learning model may include determining one or more machine learning parameters based on the training data. In some embodiments, the quantum machine learning model may obtain additional data points and/or load additional data points into a quantum state to satisfy one or more iteration conditions. The iteration conditions may include, for example, achieving a threshold accuracy for performance of the quantum machine learning model and/or passing a threshold number of training rounds. At block 340, the trained quantum machine learning model may be deployed to perform one or more machine learning tasks based on the machine learning parameters.

Modifications, additions, or omissions may be made to the method 300 without departing from the scope of the disclosure. For example, the designations of different elements in the manner described is meant to help explain concepts described herein and is not limiting. Further, the method 300 may include any number of other elements or may be implemented within other systems or contexts than those described.

FIG. 4 illustrates an example computing system 400, according to at least one embodiment described in the present disclosure. The computing system 400 may include a processor 410, a memory 420, a data storage 430, and/or a communication unit 440, which all may be communicatively coupled. Any or all of the system 100 of FIG. 1 may be implemented as a computing system consistent with the computing system 400, including the data partitioning module 120, the data analysis module 130, and/or the machine learning model 140.

Generally, the processor 410 may include any suitable special-purpose or general-purpose computer, computing entity, or processing device including various computer hardware or software modules and may be configured to execute instructions stored on any applicable computer-readable storage media. For example, the processor 410 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 4, it is understood that the processor 410 may include any number of processors distributed across any number of network or physical locations that are configured to perform individually or collectively any number of operations described in the present disclosure. In some embodiments, the processor 410 may interpret and/or execute program instructions and/or process data stored in the memory 420, the data storage 430, or the memory 420 and the data storage 430. In some embodiments, the processor 410 may fetch program instructions from the data storage 430 and load the program instructions into the memory 420.

After the program instructions are loaded into the memory 420, the processor 410 may execute the program instructions, such as instructions to perform any of the methods 200 and/or 300 of FIGS. 2 and 3, respectively. For example, the processor 410 may obtain a dataset, separate data points included in the dataset into a number of partitions, determine weights for each partition, determine a weighted centroid for the data set, identify a first partition having a least influence on the weighted centroid, obtain a first subset of the dataset by excluding the first partition, and/or train a machine learning model based on the first subset of the dataset.

The memory 420 and the data storage 430 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 410. For example, the memory 420 and/or the data storage 430 may store an obtained dataset as described in relation to FIGS. 1A and 2. In some embodiments, the computing system 400 may or may not include either of the memory 420 and the data storage 430.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 610 to perform a certain operation or group of operations.

The communication unit 440 may include any component, device, system, or combination thereof that is configured to transmit or receive information over a network. In some embodiments, the communication unit 440 may communicate with other devices at other locations, the same location, or even other components within the same system. For example, the communication unit 440 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 440 may permit data to be exchanged with a network and/or any other devices or systems described in the present disclosure. For example, the communication unit 440 may allow the system 400 to communicate with other systems, such as computing devices and/or other networks.

One skilled in the art, after reviewing this disclosure, may recognize that modifications, additions, or omissions may be made to the system 400 without departing from the scope of the present disclosure. For example, the system 400 may include more or fewer components than those explicitly illustrated and described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method comprising:
obtaining a dataset including a plurality of data points;
separating the dataset into a plurality of partitions based on a target number of subjects and a dimensionality of the data points included in the dataset, each of the partitions including one or more data points of the plurality of data points;
obtaining a plurality of weight vectors, each respective weight vector corresponding to a respective subject of the target number of subjects;
determining a plurality of first weighted centroids of the dataset each respective first weighted centroid corresponding to a respective subject of the target number of subjects and being determined based on the plurality of data points and a respective weight vector associated with the respective subject that corresponds to the respective first weighted centroid;
determining a plurality of first partition weights, each of the first partition weights being determined based on the respective data points included in a respective partition and one or more elements of a respective weight vector associated with the respective data points;
selecting a first partition of the plurality of partitions to remove from the dataset based on respective relationships between the first weighted centroid and each of the first partition weights;
obtaining a first subset of the dataset by removing the data points associated with the first partition from the dataset; and
training a machine learning model based on the first subset of the dataset.

2. The method of claim 1, further comprising:
determining one or more second weighted centroid of the dataset each corresponding to a respective subject of the target number of subjects, each of the second weighted centroids being determined based on the data points included in the first subset and the respective weight vector associated with the respective subject;
determining one or more second partition weights included in the first subset, each of the second partition weights being determined based on one or more elements of a weight vector associated with a respective subject of the target number of subjects;
identifying a second partition of the partitions included in the first subset having a least influence on the determining the second weighted centroid based on the second partition weights;
obtaining a second subset by removing the data points associated with the second partition from the first subset; and
training the machine learning model based on the second subset of the data set.

3. The method of claim 2, further comprising:
determining an iteration condition; and
determining whether the iteration condition is satisfied.

4. The method of claim 1, wherein the dataset is separated into 2k (d+1) partitions, wherein “k” represents the target number of points and “d” represents the dimensionality of the data points.

5. The method of claim 1, wherein selecting the first partition of the plurality of partitions to remove from the dataset comprises identifying the partition as having a least influence on the determining the first weighted centroid of the dataset by comparing the first partition weights to the first weighted centroid to determine which partitions corresponding to the first partition weights contributes the least to representation of the first weighted centroid.

6. The method of claim 1, wherein:
the machine learning model is a quantum machine learning model; and
training the quantum machine learning model comprises:
loading each data point included in the first subset into a quantum state; and
determining one or more machine-learning parameters based on the quantum data points.

7. The method of claim 6, wherein the quantum machine learning model is configured to be implemented in one or more noisy intermediate-scale quantum (NISQ) devices.

8. The method of claim 1, wherein:
the plurality of data points included in the dataset include financial or economic data; and
the machine learning model is trained to perform analysis of financial data or economic data.

9. One or more non-transitory computer-readable storage media configured to store instructions that, in response to being executed by one or more processors, cause a system to perform operations, the operations comprising:
obtaining a dataset including a plurality of data points;
separating the dataset into a plurality of partitions based on a target number of subjects and a dimensionality of the data points included in the dataset, each of the partitions including one or more data points of the plurality of data points;
obtaining a plurality of weight vectors, each respective weight vector corresponding to a respective subject of the target number of subjects;
determining a plurality of first weighted centroids of the dataset each respective first weighted centroid corresponding to a respective subject of the target number of subjects and being determined based on the plurality of data points and a respective weight vector associated with the respective subject that corresponds to the respective first weighted centroid;
determining a plurality of first partition weights, each of the first partition weights being determined based on the respective data points included in a respective partition and one or more elements of a respective weight vector associated with the respective data points;
selecting a first partition of the plurality of partitions to remove from the dataset based on respective relationships between the first weighted centroid and each of the first partition weights;
obtaining a first subset of the dataset by removing the data points associated with the first partition from the dataset; and
training a machine learning model based on the first subset of the dataset.

10. The one or more non-transitory computer-readable storage media of claim 9, the operations further comprising:
determining one or more second weighted centroid of the dataset each corresponding to a respective subject of the target number of subjects, each of the second weighted centroids being determined based on the data points included in the first subset and the respective weight vector associated with the respective subject;
determining one or more second partition weights included in the first subset, each of the second partition weights being determined based on one or more elements of a weight vector associated with a respective subject of the target number of subjects;
identifying a second partition of the partitions included in the first subset having a least influence on the determining the second weighted centroid based on the second partition weights;
obtaining a second subset by removing the data points associated with the second partition from the first subset; and
training the machine learning model based on the second subset of the data set.

11. The one or more non-transitory computer-readable storage media of claim 10, the operations further comprising:
determining an iteration condition; and
determining whether the iteration condition is satisfied.

12. The one or more non-transitory computer-readable storage media of claim 9, wherein the dataset is separated into 2k (d+1) partitions, wherein “k” represents the target number of points and “d” represents the dimensionality of the data points.

13. The one or more non-transitory computer-readable storage media of claim 9, wherein selecting the first partition of the plurality of partitions to remove from the dataset comprises identifying the partition as having a least influence on the determining the first weighted centroid of the dataset by comparing the first partition weights to the first weighted centroid to determine which partitions corresponding to the first partition weights contributes the least to representation of the first weighted centroid.

14. The one or more non-transitory computer-readable storage media of claim 9, wherein:
the machine learning model is a quantum machine learning model; and
training the quantum machine learning model comprises:
loading each data point included in the first subset into a quantum state; and
determining one or more machine-learning parameters based on the quantum data points.

15. The one or more non-transitory computer-readable storage media of claim 14, wherein the quantum machine learning model is configured to be implemented in one or more noisy intermediate-scale quantum (NISQ) devices.

16. The one or more non-transitory computer-readable storage media of claim 9, wherein:
the plurality of data points included in the dataset include financial or economic data; and
the machine learning model is trained to perform analysis of financial data or economic data.

17. A system comprising:
one or more processors; and
one or more non-transitory computer-readable storage media configured to store instructions that, in response to being executed, cause the system to perform operations, the operations comprising:
obtaining a dataset including a plurality of data points;
separating the dataset into a plurality of partitions based on a target number of subjects and a dimensionality of the data points included in the dataset, each of the partitions including one or more data points of the plurality of data points;
obtaining a plurality of weight vectors, each respective weight vector corresponding to a respective subject of the target number of subjects;
determining a plurality of first weighted centroids of the dataset each respective first weighted centroid corresponding to a respective subject of the target number of subjects and being determined based on the plurality of data points and a respective weight vector associated with the respective subject that corresponds to the respective first weighted centroid;
determining a plurality of first partition weights, each of the first partition weights being determined based on the respective data points included in a respective partition and one or more elements of a respective weight vector associated with the respective data points;
selecting a first partition of the plurality of partitions to remove from the dataset based on respective relationships between the first weighted centroid and each of the first partition weights;
obtaining a first subset of the dataset by removing the data points associated with the first partition from the dataset; and
training a machine learning model based on the first subset of the dataset.

18. The system of claim 17, the operations further comprising:
determining one or more second weighted centroid of the dataset each corresponding to a respective subject of the target number of subjects, each of the second weighted centroids being determined based on the data points included in the first subset and the respective weight vector associated with the respective subject;
determining one or more second partition weights included in the first subset, each of the second partition weights being determined based on one or more elements of a weight vector associated with a respective subject of the target number of subjects;
identifying a second partition of the partitions included in the first subset having a least influence on the determining the second weighted centroid based on the second partition weights;
obtaining a second subset by removing the data points associated with the second partition from the first subset; and
training the machine learning model based on the second subset of the data set.

19. The system of claim 18, the operations further comprising:
determining an iteration condition; and
determining whether the iteration condition is satisfied.

20. The system of claim 17, wherein:
the machine learning model is a quantum machine learning model; and
training the quantum machine learning model comprises:
loading each data point included in the first subset into a quantum state; and
determining one or more machine-learning parameters based on the quantum data points.
